(19) United States
(12) Patent Application Publication
(10) Pub. No.: US 2025/0363413 A1
(43) Pub. Date: Nov. 27, 2025

(54) MODEL TRAINING METHODS AND APPARATUSES, STORAGE MEDIA, AND ELECTRONIC DEVICES

(71) Applicant: ALIPAY (HANGZHOU) INFORMATION TECHNOLOGY CO., LTD., Hangzhou (CN)

(72) Inventor: Xinyi FU, Hangzhou (CN)

(21) Appl. No.: 18/872,511

(22) PCT Filed: Aug. 27, 2023
(86) PCT No.: PCT/CN2023/115130

§ 371 Date: Dec. 6, 2024

(30) Foreign Application Priority Data
Dec. 30, 2022 (CN) 202211739985.0

(51) Int. Cl. G06N 20/00; G06F 21/53

(52) U.S. Cl. CPC G06N 20/00; G06F 21/53

(57) ABSTRACT

This specification discloses model training methods and apparatuses, storage media, and electronic devices. In embodiments of this specification, after obtaining a model parameter from a first server, a node device generates a target model based on the model parameter, trains the target model to obtain gradient data generated during the training of the target model, filters, based on a predetermined gradient threshold, out data, in the gradient data, that does not meet a training condition needed by the first server for model training, to obtain target data, and sends the target data to the first server. The first server adjusts the model parameter based on the target data and gradient data sent by another node device, generates a model, and deploys the generated model in the first server to train the generated model.

### TECHNICAL FIELD

This specification relates to the field of computer technologies, and in particular, to model training methods and apparatuses, storage media, and electronic devices.

### BACKGROUND

With the development of science and technologies, models can be obtained from cloud servers and deployed on user terminals, so that the models provide services such as image recognition, information recommendation, and privacy protection for users.

When the models in the cloud servers are trained, the models to be trained can be deployed on various user terminals. Then, for each user terminal, the user terminal trains the deployed model by using local training samples, to obtain gradient information, and uploads the gradient information to the cloud servers. The cloud servers train the models in the cloud servers based on the gradient information uploaded by each user terminal.

However, training methods currently used reduce training efficiency of the models in the cloud servers.

### SUMMARY

Embodiments of this specification provide model training methods and apparatuses, storage media, and electronic devices.

The following technical solutions are used in the embodiments of this specification. This specification provides a model training method. The method is used for distributed training, a system on which the distributed training is based includes a first server and one or more node devices, and the method includes: The node device obtains a model parameter from the first server; generates a target model based on the model parameter; trains the target model to obtain gradient data generated during the training of the target model; filters, based on a predetermined gradient threshold, out data, in the gradient data, that does not meet a training condition needed by the first server for model training, to obtain target data; and sends the target data to the first server, so that the first server adjusts the model parameter based on the received target data sent by the node device and gradient data sent by another node device, generates a model based on an adjusted model parameter, and deploys the generated model in the first server to train the generated model.

Optionally, the filtering, based on a predetermined gradient threshold, out data, in the gradient data, that does not meet a training condition needed by the first server for model training specifically includes: performing noise addition processing on the predetermined gradient threshold to obtain a processed gradient threshold; and filtering, based on the processed gradient threshold, out the data, in the gradient data, that does not meet the training condition needed by the first server for model training.

Optionally, the filtering, based on the processed gradient threshold, out the data, in the gradient data, that does not meet the training condition needed by the first server for model training specifically includes: for each data in the gradient data, comparing the data with the processed gradient threshold; and if the data is greater than the processed gradient threshold, retaining the data; or if the data is not greater than the processed gradient threshold, filtering out the data.

Optionally, the sending the target data to the first server, so that the first server adjusts the model parameter based on the received target data sent by the node device and gradient data sent by another node device specifically includes: performing noise addition processing on the target data to obtain processed target data; and sending the processed target data to the first server, so that the first server adjusts the model parameter based on the received processed target data sent by the node device and the gradient data sent by the another node device.

Optionally, the filtering, based on a predetermined gradient threshold, out data, in the gradient data, that does not meet a training condition needed by the first server for model training, to obtain target data specifically includes: sending the gradient data to a second server, so that the second server filters, based on the predetermined gradient threshold, out the data, in the gradient data, that does not meet the training condition needed by the first server for model training, to obtain the target data; and the sending the target data to the first server specifically includes: sending the target data to the first server via the second server.

Optionally, the sending the gradient data to a second server specifically includes: encrypting the gradient data to obtain ciphertext data; and sending the ciphertext data to the second server.

Optionally, a running environment of the second server is a trusted execution environment (TEE).

This specification provides a model training apparatus, including an obtaining module, configured by a node device to obtain a model parameter from a first server; a generation module, configured to generate a target model based on the model parameter; a gradient data determining module, configured to train the target model to obtain gradient data generated during the training of the target model; a filtering module, configured to filter, based on a predetermined gradient threshold, out data, in the gradient data, that does not meet a training condition needed by the first server for model training, to obtain target data; and a training module, configured to send the target data to the first server, so that the first server adjusts the model parameter based on the received target data sent by the node device and gradient data sent by another node device, generates a model based on an adjusted model parameter, and deploys the generated model in the first server to train the generated model.

This specification provides a non-transitory computer-readable storage medium. The storage medium stores a computer program, and when the computer program is executed by a processor, the model training method is implemented.

This specification provides an electronic device, including a memory, a processor, and a computer program that is stored in the memory and that is capable of running on the processor. When the processor executes the program, the model training method is implemented.

The above-mentioned at least one technical solution used in the embodiments of this specification can achieve the following beneficial effects: In the embodiments of this specification, after obtaining the model parameter from the first server, the node device generates the target model based on the model parameter, trains the target model to obtain the gradient data generated during the training of the target model, then filters, based on the predetermined gradient threshold, out the data, in the gradient data, that does not meet the training condition needed by the first server for model training, to obtain the target data, and sends the target data to the first server. The first server adjusts the model parameter based on the target data sent by the node device and the gradient data sent by the another node device, generates the model, and deploys the generated model in the first server to train the generated model. In the method, the target data that meets the training condition is selected from the gradient data, and the model parameter is adjusted based on the target data instead of all gradient data. In this way, training efficiency of the generated model in the first server can be improved.

### BRIEF DESCRIPTION OF DRAWINGS

The accompanying drawings described here are used to provide a further understanding of this specification, and constitute a part of this specification. Example embodiments of this specification and descriptions of the embodiments are used to explain this specification, and do not constitute an inappropriate limitation on this specification.

FIG. 1 is a schematic flowchart illustrating a model training method, according to one or more embodiments of this specification;

FIG. 2 is a schematic diagram illustrating a structure of a model training apparatus, according to one or more embodiments of this specification; and

FIG. 3 is a schematic diagram illustrating a structure of an electronic device, according to one or more embodiments of this specification.

### DESCRIPTION OF EMBODIMENTS

To make the objectives, technical solutions, and advantages of this specification clearer, the following clearly and comprehensively describes the technical solutions of this specification with reference to specific embodiments and accompanying drawings of this specification. Clearly, the described embodiments are merely some but not all of the embodiments of this specification. All other embodiments obtained by a person of ordinary skill in the art based on the embodiments of this specification without creative efforts shall fall within the protection scope of this specification.

The following describes in detail the technical solutions provided in the embodiments of this specification with reference to the accompanying drawings.

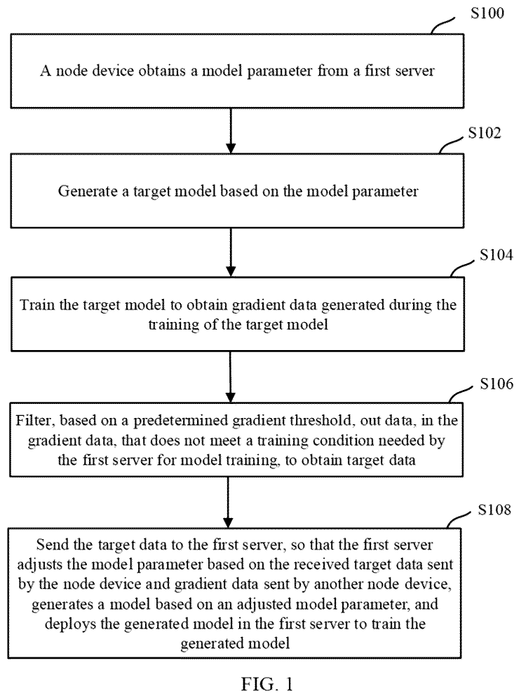

FIG. 1 is a schematic flowchart illustrating a model training method, according to this specification. The model training method is used for distributed training, and a system on which the distributed training is based can include a first server and one or more node devices. The model training method can be applied to any node device, and includes step S100 to step S108.

S100: The node device obtains a model parameter from the first server.

S102: Generate a target model based on the model parameter.

In one or more embodiments of this specification, the first server can be a cloud server, a model can be deployed in the first server, and the model in the first server can be a model used to execute a service. A service type can include a recommendation service, a query service, a payment service, a privacy protection service, an image recognition service, a voice recognition service, etc.

For each iterative training of the model in the first server, the first server can randomly select at least some node devices from the node devices in the system. Then, the first server can send the model parameter of the model in the first server to the selected at least some node devices. The node device can be a client device.

For any node device, the node device receives the model parameter sent by the first server. In other words, the node device obtains the model parameter from the first server, and then generates the target model based on the obtained model parameter. The obtained model parameter is a model parameter of a model that is regenerated after model parameter adjustment is performed on the model in the first server during previous iterative training. The target model can be a model deployed on the node device, and a model structure of the target model is the same as a model structure of the model in the first server.

When generating the target model, the node device can update, to the obtained model parameter, a model parameter of the model deployed on the node device during the previous iterative training, and use an updated model deployed on the node device as the target model.

In addition, if the model is not deployed on the node device during the previous iterative training, the node device can directly assign the obtained model parameter to a model with the same model structure as the model in the first server, to generate the target model.

S104: Train the target model to obtain gradient data generated during the training of the target model.

In one or more embodiments of this specification, after generating the target model, the node device can obtain local historical service data of the node device based on a service requirement, and train the target model based on the historical service data to obtain the gradient data generated during the training of the target model. The gradient data can be a gradient matrix.

During the training of the target model, the local historical service data of the node device can be first obtained, and then the obtained historical service data is input into the target model, to output a result by using the target model. The gradient data generated during the training of the target model is determined based on a difference between the result output by the target model and a label.

S106: Filter, based on a predetermined gradient threshold, out data, in the gradient data, that does not meet a training condition needed by the first server for model training, to obtain target data.

S108: Send the target data to the first server, so that the first server adjusts the model parameter based on the received target data sent by the node device and gradient data sent by another node device, generates a model based on an adjusted model parameter, and deploys the generated model in the first server to train the generated model.

In one or more embodiments of this specification, after obtaining the gradient data generated during the training of the target model, the node device can filter, based on the predetermined gradient threshold, out the data, in the gradient data, that does not meet the training condition needed by the first server for model training, to obtain the target data, and then send the target data to the first server. The first server adjusts the model parameter of the model in the server based on the received target data and the gradient data sent by the another node device, and regenerates the model based on the adjusted model parameter, and deploy the regenerated model in the first server to continue training the regenerated model. The training condition needed by the first server for model training can be data important to the model training. That is, based on the predetermined gradient threshold, data that is not important to the model training in the gradient data is filtered out. In other words, data that is less than the gradient threshold is filtered out. In addition, the data that does not meet the training condition needed by the first server for model training can alternatively be data whose gradient data generated during each iterative training is unchanged or whose change difference falls within a specified range in iterative training for a specified quantity of consecutive times.

When the data, in the gradient data, that does not meet the training condition needed by the first server for model training is filtered out, for each data in the gradient data, the data can be compared with the gradient threshold. If the data is greater than the gradient threshold, the data is retained, and the data is used as the target data. If the data is not greater than the gradient threshold, the data is filtered out.

When the gradient data is a gradient matrix, the gradient threshold can be a gradient threshold matrix, and the target data can be a target gradient matrix.

When the data, in the gradient data, that does not meet the training condition needed by the first server for model training is filtered out, for each gradient value in the gradient matrix, the gradient value can be compared with a gradient threshold at a location corresponding to the gradient value in the gradient threshold matrix. If the gradient value is greater than the gradient threshold, the gradient value is retained. If the gradient value is not greater than the gradient threshold, the gradient value is set to zero. Finally, a filtered gradient matrix is used as the target gradient matrix.

In addition, to prevent leakage of the gradient data generated during the training of the target model due to leakage of the gradient threshold, the first server can first determine the predetermined gradient threshold, and then process the gradient threshold to obtain a processed gradient threshold. Processing the gradient threshold can include noise addition, encryption, a hash operation, etc. Finally, the processed gradient threshold is sent to the node device. The node device receives the processed threshold matrix sent by the first server, and can filter, based on the processed gradient threshold, out the data, in the gradient data, that does not meet the training condition needed by the first server for model training, to obtain the target data.

Specifically, for each data in the gradient data, the data can be compared with the processed gradient threshold. If the data is greater than the processed gradient threshold, the data is retained, and the data is used as the target data. If the data is not greater than the processed gradient threshold, the data is filtered out.

Moreover, in addition to the method in which the first server processes the gradient threshold, the node device can alternatively process the gradient threshold. Processing the gradient threshold can include noise addition, encryption, a hash operation, etc.

Specifically, the node device can obtain the gradient threshold from the first server, and then can process the gradient threshold to obtain a processed gradient threshold. Then, the node device filters, based on the processed gradient threshold, out the data, in the gradient data, that does not meet the training condition needed by the first server for model training, to obtain the target data.

When the gradient data is a gradient matrix, the gradient threshold matrix obtained after the gradient threshold is processed can be a processed gradient threshold matrix, and the target data can be a target gradient matrix.

Specifically, for each gradient value in the gradient matrix, the gradient value is compared with a gradient threshold at a location corresponding to the gradient value in the processed gradient threshold matrix. If the gradient value is greater than the gradient threshold, the gradient value is retained. If the gradient value is not greater than the gradient threshold, the gradient value is set to zero. Finally, a filtered gradient matrix is used as the target gradient matrix.

After the target data is obtained, the node device can send the target data to the first server. The first server adjusts the model parameter based on the received target data and the gradient data sent by the another node device, generates the model based on the adjusted model parameter, and deploys the generated model in the first server to train the generated model. The gradient data sent by the another node device can be all gradient data generated when the another node device trains the target model, or can be target data obtained after the another node device filters out data that does not meet the training condition needed by the first server for model training.

When the another node device sends the target data, the first server can receive the target data sent by each node device, and then determine comprehensive gradient data based on the target data sent by each node device. Finally, the first server adjusts the model parameter based on the comprehensive gradient data, to obtain an adjusted model parameter, generates a model based on the adjusted model parameter, and deploys the generated model in the first server to train the generated model, that is, can use the adjusted model parameter as the model parameter of the target model during next iterative training.

When determining the comprehensive gradient data, the first server can perform weighted summation on various target data to obtain the comprehensive gradient data. A sum of weights corresponding to all target data is 1.

In addition, to further protect the target data from being leaked, the node device can process the target data to obtain processed target data. A method for processing the target data may include noise addition, encryption, a hash operation, etc.

In this case, the node device can send the processed target data to the first server. The first server adjusts the model parameter based on the received processed target data and the gradient data sent by the another node device, generates the model based on the adjusted model parameter, and deploys the generated model in the first server to train the generated model.

In addition, during each iterative training, a privacy computing resource needs to be consumed when the gradient data generated during the training of the target model is processed, and a larger amount of gradient data causes a larger quantity of privacy computing resources to be consumed. Therefore, in this specification, when the target data is processed, only a part of the gradient data is processed, to reduce a privacy computing resource consumed during one iterative training. In this way, in a case of a fixed privacy computing resource, a quantity of iterative training times of using a training method in which the target data is processed is larger than a quantity of iterative training times of using a training method in which all gradient data is processed, to improve a training effect of the model in the first server.

In steps S106 to S108, only data greater than the gradient threshold in the gradient data is retained, and a model parameter order of the model and the target model in the first server can be greatly reduced, to improve training efficiency of the model and the target model in the first server. In addition, in a case in which the gradient threshold is not processed, the node device sends only the target data greater than the gradient threshold in the gradient data to the first server. Even if the target data is leaked, the attacker obtains only a part of the gradient data, and it is difficult to restore service data for training the target model from the part of the gradient data. Moreover, in this specification, noise addition and encryption processing can be further performed on the gradient threshold. Furthermore, alternatively, after processing the target data, the node device can send the processed target data to the first server.

It can be learned from the above-mentioned method shown in FIG. 1 that in this specification, after obtaining the model parameter from the first server, the node device generates the target model based on the model parameter, trains the target model to obtain the gradient data generated during the training of the target model, then filters, based on the predetermined gradient threshold, out the data, in the gradient data, that does not meet the training condition needed by the first server for model training, to obtain the target data, and sends the target data to the first server. The first server adjusts the model parameter based on the target data sent by the node device and the gradient data sent by the another node device, generates the model, and deploys the generated model in the first server to train the generated model. In the method, the target data that meets the training condition is selected from the gradient data, and the model parameter is adjusted based on the target data instead of all gradient data. In this way, training efficiency of the generated model in the first server can be improved.

Further, in S106 to S108, after the node device obtains the gradient data generated during the training of the target model, in addition to filtering the gradient data by the node device, the node device can further send the gradient data to a second server. The second server can be a server that can implement processing such as noise addition and encryption, and a filtering function, and a running environment of the second server is a trusted execution environment (TEE). Because the second server is in the trusted execution environment, the gradient data is not leaked.

After the second server receives the gradient data sent by the node device, the second server can obtain the gradient threshold from the first server. Then, the second server can filter, based on the gradient threshold, out data, in the gradient data, that does not meet the training condition needed by the first server for model training, to obtain target data. A filtering method of the second server is the same as the filtering method of the node device, and details are omitted here for simplicity.

In addition, to prevent leakage of the gradient data, the node device can first encrypt the gradient data to obtain ciphertext data for the gradient data, and then send the ciphertext data to the second server. Then, the second server needs to decrypt the ciphertext data to obtain the gradient data. Finally, the second server can filter, based on the gradient threshold, out the data, in the gradient data, that does not meet the training condition needed by the first server for model training, to obtain the target data.

Similarly, to avoid leakage of the gradient data due to the gradient threshold, the second server can process the gradient threshold to obtain a processed gradient threshold, and then filters, based on the processed gradient threshold, out the data, in the gradient data, that does not meet the training condition needed by the first server for model training, to obtain the target data.

After the second server obtains the target data, the second server can send the target data to the first server, so that the first server adjusts the model parameter based on the target data and the gradient data sent by the another node device, generates the model based on the adjusted model parameter, and deploys the generated model in the first server to train the generated model.

In addition, to further protect the gradient data, the second server can process the target data to obtain processed target data, and then send the processed target data to the first server, so that the first server adjusts the model parameter based on the received processed target data and the gradient data sent by the another node device, generates the model based on the adjusted model parameter, and deploys the generated model in the first server to train the generated model.

Moreover, in addition to directly sending the target data or the processed target data to the first server by the second server, when there are a plurality of node devices, the second server can obtain target data generated when various node devices train the target model, then perform weighted summation on various target data to obtain aggregated gradient data, and finally, send the aggregated gradient data to the first server, so that the first server adjusts the model parameter based on the received aggregated gradient data, generates a model based on an adjusted model parameter, and deploys the generated model in the first server to train the generated model.

In addition, to reduce the privacy computing resource, noise addition processing can be performed on the aggregated gradient data to obtain comprehensive gradient data, and the comprehensive gradient data is sent to the first server, so that the first server adjusts the model parameter based on the comprehensive gradient data, generates a model based on an adjusted model parameter, and deploys the generated model in the first server to train the generated model.

The model training methods provided in the embodiments of this specification are described above. Based on the same idea, this specification further provides corresponding apparatuses, storage media, and electronic devices.

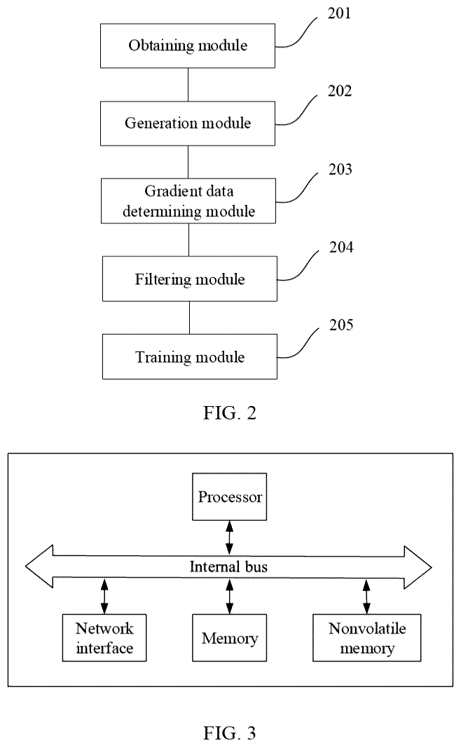

FIG. 2 is a schematic diagram illustrating a structure of a model training apparatus, according to one or more embodiments of this specification. The apparatus includes an obtaining module 201, configured by a node device to obtain a model parameter from the first server; a generation module 202, configured to generate a target model based on the model parameter; a gradient data determining module 203, configured to train the target model to obtain gradient data generated during the training of the target model; a filtering module 204, configured to filter, based on a predetermined gradient threshold, out data, in the gradient data, that does not meet a training condition needed by the first server for model training, to obtain target data; and a training module 205, configured to send the target data to the first server, so that the first server adjusts the model parameter based on the received target data sent by the node device and gradient data sent by another node device, generates a model based on an adjusted model parameter, and deploys the generated model in the first server to train the generated model.

Optionally, the filtering module 204 is specifically configured to perform noise addition processing on the predetermined gradient threshold to obtain a processed gradient threshold; and filter, based on the processed gradient threshold, out the data, in the gradient data, that does not meet the training condition needed by the first server for model training.

Optionally, the filtering module 204 is specifically configured to: for each data in the gradient data, compare the data with the processed gradient threshold; and if the data is greater than the processed gradient threshold, retain the data; or if the data is not greater than the processed gradient threshold, filter out the data.

Optionally, the filtering module 204 is specifically configured to send the gradient data to a second server, so that the second server filters, based on the predetermined gradient threshold, out the data, in the gradient data, that does not meet the training condition needed by the first server for model training, to obtain the target data.

Optionally, the filtering module 204 is specifically configured to encrypt the gradient data to obtain ciphertext data; and send the ciphertext data to the second server.

Optionally, the training module 205 is specifically configured to perform noise addition processing on the target data to obtain processed target data; and send the processed target data to the first server, so that the first server adjusts the model parameter based on the received processed target data sent by the node device and the gradient data sent by the another node device.

Optionally, the training module 205 is specifically configured to send the target data to the first server via the second server.

Optionally, a running environment of the second server is a trusted execution environment (TEE).

This specification further provides a computer-readable storage medium. The storage medium stores a computer program, and when the computer program is executed by a processor, the model training method provided in FIG. 1 can be performed.

Based on the model training method shown in FIG. 1, one or more embodiments of this specification further provide a schematic diagram illustrating a structure of an electronic device shown in FIG. 3. As shown in FIG. 3, in terms of hardware, the electronic device includes a processor, an internal bus, a network interface, a memory, and a nonvolatile memory, and certainly may further include hardware needed by another service. The processor reads a corresponding computer program from the nonvolatile memory into the memory and then runs the computer program, to implement the model training method shown in FIG. 1.

Certainly, in addition to software implementations, another implementation is not excluded in this specification, for example, a logic device or a combination of hardware and software. In other words, an execution body of the following processing process is not limited to logical units, and can be hardware or a logic device.

In the 1990s, whether a technical improvement is a hardware improvement (for example, an improvement to a circuit structure, such as a diode, a transistor, or a switch) or a software improvement (an improvement to a method procedure) can be clearly distinguished. However, with the development of technologies, improvements to many existing method procedures can be considered as direct improvements to hardware circuit structures. A designer usually programs an improved method procedure to a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and manufacture an application-specific integrated circuit chip. In addition, at present, instead of manually manufacturing an integrated circuit chip, this type of programming is mostly implemented by using “logic compiler” software. The programming is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. It should also be clear to a person skilled in the art that a hardware circuit that implements a logical method procedure can be readily obtained once the method procedure is logically programmed by using the several hardware description languages described above and is programmed into an integrated circuit.

A controller can be implemented by using any appropriate method. For example, the controller can be a microprocessor or a processor, or a computer readable medium that stores computer-readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. A storage controller can also be implemented as a part of the control logic of the storage. A person skilled in the art also knows that, in addition to implementing the controller by using only computer-readable program code, logic programming can be performed on a method step, so the controller implements a same function in a form of a logic gate, a switch, an application-specific integrated circuit, a programmable logic controller, an embedded microcontroller, etc. Therefore, the controller can be considered as a hardware component, and an apparatus included in the controller and configured to implement various functions can also be considered as a structure in the hardware component. Or the apparatus configured to implement various functions can even be considered as both a software module implementing the method and a structure in the hardware component.

The system, apparatus, module, or unit illustrated in the above-mentioned. embodiments can be implemented by using a computer chip or an entity, or can be implemented by using a product having a certain function. A typical implementation device is a computer. Specifically, for example, the computer can be a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above-mentioned apparatus is described by dividing functions into various units. Certainly, during implementation of this specification, functions of units can be implemented in the same or more software or hardware.

A person skilled in the art should understand that the embodiments of this specification can be provided as methods, systems, or computer program products. Therefore, a form of hardware only embodiments, software only embodiments, or embodiments with a combination of software and hardware can be used in this specification. Furthermore, this specification can be used in a form of a computer program product implemented on one or more computer-usable storage media (including but not limited to a disk memory, a CD-ROM, an optical memory, etc.) including computer-usable program code.

This specification is described with reference to the flowcharts and/or block diagrams of the method, the device (system), and the computer program product according to the embodiments of this specification. It should be understood that computer program instructions can be used to implement each procedure and/or each block in the flowcharts and/or the block diagrams and a combination of a procedure and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more procedures in the flowcharts and/or in one or more blocks in the block diagrams.

These computer program instructions can also be stored in a computer readable memory that can instruct a computer or another programmable data processing device to work in a specific manner, so that an instruction stored in the computer readable memory generates a manufacturer including an instruction apparatus, and the instruction apparatus implements a specific function in one or more procedures in the flowcharts and/or one or more blocks in the block diagrams.

The computer program instructions can alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPUs), one or more input/output interfaces, one or more network interfaces, and one or more memories.

The memory can include a form such as a non-permanent memory, a random access memory (RAM), or a nonvolatile memory in a computer-readable medium, for example, a read-only memory (ROM) or a flash memory (flash RAM). The memory is an example of the computer-readable medium

Computer-readable media, including permanent and non-permanent, removable and non-removable media, can be implemented by any method or technology for information storage. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be configured to store information that can be accessed by a computing device. Based on the definition in this specification, the computer-readable medium does not include transitory media such as a modulated data signal and carrier.

It is worthwhile to further note that the terms “include”, “comprise”, or any other variants thereof are intended to cover a non-exclusive inclusion, so that a process, a method, a product, or a device that includes a list of elements not only includes those elements but also includes other elements which are not expressly listed, or further includes elements inherent to such s process, method, product, or device. Without more constraints, an element preceded by “includes a . . . ” does not preclude the presence of additional identical elements in the process, method, product, or device that includes the element.

A person skilled in the art should understand that the embodiments of this specification can be provided as methods, systems, or computer program products. Therefore, a form of hardware only embodiments, software only embodiments, or embodiments with a combination of software and hardware can be used in this specification. Furthermore, this specification can be used in a form of a computer program product implemented on one or more computer-usable storage media (including but not limited to a disk memory, a CD-ROM, an optical memory, etc.) including computer-usable program code.

This specification can be described in a general context of a computer-executable instruction executed by a computer, for example, a program module. Generally, the program module includes a routine, a program, an object, a component, a data structure, etc. for executing a specific task or implementing a specific abstract data type. This specification can alternatively be practiced in distributed computing environments. In the distributed computing environments, tasks are executed by remote processing devices connected through a communication network. In the distributed computing environment, a program module can be located in local and remote computer storage media including a storage device.

The embodiments of this specification are described in a progressive manner. For the same or similar parts in the embodiments, refer to each other. Each embodiment focuses on a difference from other embodiments. Particularly, the system embodiment is basically similar to the method embodiment, and therefore is briefly described. For a related part, refer to some descriptions in the method embodiment.

The above-mentioned descriptions are merely some embodiments of this specification and are not intended to limit this specification. A person skilled in the art can make various changes and variations to this specification. Any modification, equivalent replacement, or improvement made without departing from the spirit and principle of this specification shall fall within the scope of the claims in this specification.

1. A model training method, wherein the method is used for distributed training, a system on which the distributed training is based comprises a first server and one or more node devices, and the method comprises:
obtaining, by the node device, a model parameter from the first server;
generating a target model based on the model parameter;
training the target model to obtain gradient data generated during the training of the target model;
filtering, based on a predetermined gradient threshold, out data, in the gradient data, that does not meet a training condition needed by the first server for model training, to obtain target data; and
sending the target data to the first server, so that the first server adjusts the model parameter based on the received target data sent by the node device and gradient data sent by another node device, generates a model based on an adjusted model parameter, and deploys the generated model in the first server to train the generated model.

2. The method according to claim 1, wherein the filtering, based on a predetermined gradient threshold, out data, in the gradient data, that does not meet a training condition needed by the first server for model training comprises:
performing noise addition processing on the predetermined gradient threshold to obtain a processed gradient threshold; and
filtering, based on the processed gradient threshold, out the data, in the gradient data, that does not meet the training condition needed by the first server for model training.

3. The method according to claim 2, wherein the filtering, based on the processed gradient threshold, out the data, in the gradient data, that does not meet the training condition needed by the first server for model training comprises:
for each data in the gradient data, comparing the data with the processed gradient threshold; and
upon determining that the data is greater than the processed gradient threshold, retaining the data; or
upon determining that the data is not greater than the processed gradient threshold, filtering out the data.

4. The method according to claim 1, wherein the sending the target data to the first server, so that the first server adjusts the model parameter based on the received target data sent by the node device and gradient data sent by another node device comprises:
performing noise addition processing on the target data to obtain processed target data; and
sending the processed target data to the first server, so that the first server adjusts the model parameter based on the received processed target data sent by the node device and the gradient data sent by the another node device.

5. The method according to claim 1, wherein the filtering, based on a predetermined gradient threshold, out data, in the gradient data, that does not meet a training condition needed by the first server for model training, to obtain target data comprises:
sending the gradient data to a second server, so that the second server filters, based on the predetermined gradient threshold, out the data, in the gradient data, that does not meet the training condition needed by the first server for model training, to obtain the target data; and
the sending the target data to the first server comprises:
sending the target data to the first server via the second server.

6. The method according to claim 5, wherein the sending the gradient data to a second server comprises:
encrypting the gradient data to obtain ciphertext data; and
sending the ciphertext data to the second server.

7. The method according to claim 5, wherein a running environment of the second server is a trusted execution environment (TEE).

8. (canceled)

9. A non-transitory computer-readable storage medium, wherein the storage medium stores a computer program, and when the computer program is executed by a processor, causes the processor to implement a model training method, wherein the method is used for distributed training, a system on which the distributed training is based comprises a first server and one or more node devices, and the method comprises:
obtaining, by the node device, a model parameter from the first server;
generating a target model based on the model parameter;
training the target model to obtain gradient data generated during the training of the target model;
filtering, based on a predetermined gradient threshold, out data, in the gradient data, that does not meet a training condition needed by the first server for model training, to obtain target data; and
sending the target data to the first server, so that the first server adjusts the model parameter based on the received target data sent by the node device and gradient data sent by another node device, generates a model based on an adjusted model parameter, and deploys the generated model in the first server to train the generated model.

10. An electronic device, comprising a memory, a processor, and a computer program that is stored in the memory and that is capable of running on the processor, wherein when the processor executes the program, the processor is caused to implement a model training method, wherein the method is used for distributed training, a system on which the distributed training is based comprises a first server and one or more node devices, and the method comprises:
obtaining, by the node device, a model parameter from the first server;
generating a target model based on the model parameter;
training the target model to obtain gradient data generated during the training of the target model;
filtering, based on a predetermined gradient threshold, out data, in the gradient data, that does not meet a training condition needed by the first server for model training, to obtain target data; and
sending the target data to the first server, so that the first server adjusts the model parameter based on the received target data sent by the node device and gradient data sent by another node device, generates a model based on an adjusted model parameter, and deploys the generated model in the first server to train the generated model.

11. The non-transitory computer-readable storage medium according to claim 9, wherein the filtering, based on a predetermined gradient threshold, out data, in the gradient data, that does not meet a training condition needed by the first server for model training comprises:
performing noise addition processing on the predetermined gradient threshold to obtain a processed gradient threshold; and
filtering, based on the processed gradient threshold, out the data, in the gradient data, that does not meet the training condition needed by the first server for model training.

12. The non-transitory computer-readable storage medium according to claim 11, wherein the filtering, based on the processed gradient threshold, out the data, in the gradient data, that does not meet the training condition needed by the first server for model training comprises:
for each data in the gradient data, comparing the data with the processed gradient threshold; and
upon determining that the data is greater than the processed gradient threshold, retaining the data; or
upon determining that the data is not greater than the processed gradient threshold, filtering out the data.

13. The non-transitory computer-readable storage medium according to claim 9, wherein the sending the target data to the first server, so that the first server adjusts the model parameter based on the received target data sent by the node device and gradient data sent by another node device comprises:
performing noise addition processing on the target data to obtain processed target data; and
sending the processed target data to the first server, so that the first server adjusts the model parameter based on the received processed target data sent by the node device and the gradient data sent by the another node device.

14. The non-transitory computer-readable storage medium according to claim 9, wherein the filtering, based on a predetermined gradient threshold, out data, in the gradient data, that does not meet a training condition needed by the first server for model training, to obtain target data comprises:
sending the gradient data to a second server, so that the second server filters, based on the predetermined gradient threshold, out the data, in the gradient data, that does not meet the training condition needed by the first server for model training, to obtain the target data; and
the sending the target data to the first server comprises:
sending the target data to the first server via the second server.

15. The non-transitory computer-readable storage medium according to claim 14, wherein the sending the gradient data to a second server comprises:
encrypting the gradient data to obtain ciphertext data; and
sending the ciphertext data to the second server.

16. The electronic device according to claim 10, wherein the filtering, based on a predetermined gradient threshold, out data, in the gradient data, that does not meet a training condition needed by the first server for model training comprises:
performing noise addition processing on the predetermined gradient threshold to obtain a processed gradient threshold; and
filtering, based on the processed gradient threshold, out the data, in the gradient data, that does not meet the training condition needed by the first server for model training.

17. The electronic device according to claim 16, wherein the filtering, based on the processed gradient threshold, out the data, in the gradient data, that does not meet the training condition needed by the first server for model training comprises:
for each data in the gradient data, comparing the data with the processed gradient threshold; and
upon determining that the data is greater than the processed gradient threshold, retaining the data; or
upon determining that the data is not greater than the processed gradient threshold, filtering out the data.

18. The electronic device according to claim 10, wherein the sending the target data to the first server, so that the first server adjusts the model parameter based on the received target data sent by the node device and gradient data sent by another node device comprises:
performing noise addition processing on the target data to obtain processed target data; and
sending the processed target data to the first server, so that the first server adjusts the model parameter based on the received processed target data sent by the node device and the gradient data sent by the another node device.

19. The electronic device according to claim 10, wherein the filtering, based on a predetermined gradient threshold, out data, in the gradient data, that does not meet a training condition needed by the first server for model training, to obtain target data comprises:
sending the gradient data to a second server, so that the second server filters, based on the predetermined gradient threshold, out the data, in the gradient data, that does not meet the training condition needed by the first server for model training, to obtain the target data; and
the sending the target data to the first server comprises:
sending the target data to the first server via the second server.

20. The electronic device according to claim 19, wherein the sending the gradient data to a second server comprises:
encrypting the gradient data to obtain ciphertext data; and
sending the ciphertext data to the second server.

21. The electronic device according to claim 19, wherein a running environment of the second server is a trusted execution environment (TEE).
